(19) United States
(12) Patent Application Publication
(10) Pub. No.: US 2008/0128335 A1
(43) Pub. Date: Jun. 5, 2008

(54) SEPARATING MACHINES INCLUDING ADJUSTABLE TROMMEL CLEANING APPARATUS AND METHODS OF USE

(76) Inventor: Matthew J. Ernst, North Oaks, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/948,280

(22) Filed: Nov. 30, 2007

Related U.S. Application Data
(60) Provisional application No. 60/868,186, filed on Dec. 1, 2006.

(51) Int. Cl. B07B 1/54; B07B 13/04

(52) U.S. Cl. 209/487; 209/44; 209/689

(57) ABSTRACT

A trommel cleaning apparatus is supported by at least one carrier guide, which allows for movement of the cleaning apparatus from a first position to a second position in order to adjust a cleaning contact force between at least one cleaning element of the cleaning apparatus and the trommel. A driver assembly may be provided to move the cleaning apparatus between the first and second positions.

### RELATED APPLICATION

This application claims priority to U.S. provisional application, Ser. No. 60/868,186, which was filed on Dec. 1, 2006, and which is hereby incorporated by reference, in its entirety.

### FIELD OF THE INVENTION

The present disclosure pertains to separating machines, for example, grain separators, and more particularly to trommel cleaning apparatuses employed therein.

### BACKGROUND

Separating machines, for example, grain separators, are typically used to separate a stream of grain containing various types and sizes of grain into its constituent parts, for example, wheat, durum, oats, barley and rice, and/or to separate such grains from other seed contaminants. These machines may employ a rotating member, or trommel, into which a stream of particulate matter is fed, and whose sidewall has a plurality of specifically sized apertures; the apertures allow passage of those particles whose size fits through the apertures; the particles, such as seed corn, barley, oats, etc., is thus sorted according to size. A trommel can alternatively be referred to as a “precision sizer.”

The efficiency of sorting operations carried out by a trommel can be significantly compromised when particles which are just slightly greater in size than the trommel apertures become stuck in the apertures. Thus, many separating machines include a trommel cleaning apparatus, which is mounted alongside the trommel and contacts the sidewall of the rotating trommel in order to force the stuck particles out from the apertures. One such apparatus is shown in FIG. 1A. FIG. 1A is a front elevation view inside a portion of a separating machine 800, which includes a trommel 80 that is located between a first sidewall 111 and a second sidewall 112 of a framework of machine 800, and a trommel cleaning apparatus 85, which likewise is located between first and second sidewalls 111, 112. Cleaning apparatus 85 is shown including cleaning elements 155, mounted on a shaft 850, alongside trommel 80, in order to contact a sidewall of trommel 80, as trommel 80 is rotated, and to thereby force stuck particles out from the apertures in the sidewall. The operation of machine 800, and the design of cleaning apparatus 85, is described in greater detail in commonly assigned U.S. Pat. No. 5,605,233, pertinent portions of which are hereby incorporated by reference.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1A is a front elevation view inside a portion of a separating machine.

FIG. 1B is an exploded perspective view of a portion of a trommel cleaning apparatus, which is employed by the machine shown in FIG. 1A, and portions of which may be employed by embodiments of the invention.

FIG. 2 is a front elevation view of a portion of a separating machine, with a front panel removed, according to some embodiments of the invention.

FIG. 3A is a front elevation view of a portion of a separating machine, with a front panel removed and including a powered driver assembly, according to some embodiments of the invention.

FIG. 3B is an end view of the separating machine shown in FIG. 3A.

FIG. 3C is a schematic top view of a portion of the machine shown in FIGS. 3A-B, according to some embodiments.

FIGS. 4A-B are schematics showing first and second positions, respectively, of a trommel cleaning apparatus, according to some embodiments of the invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the invention.

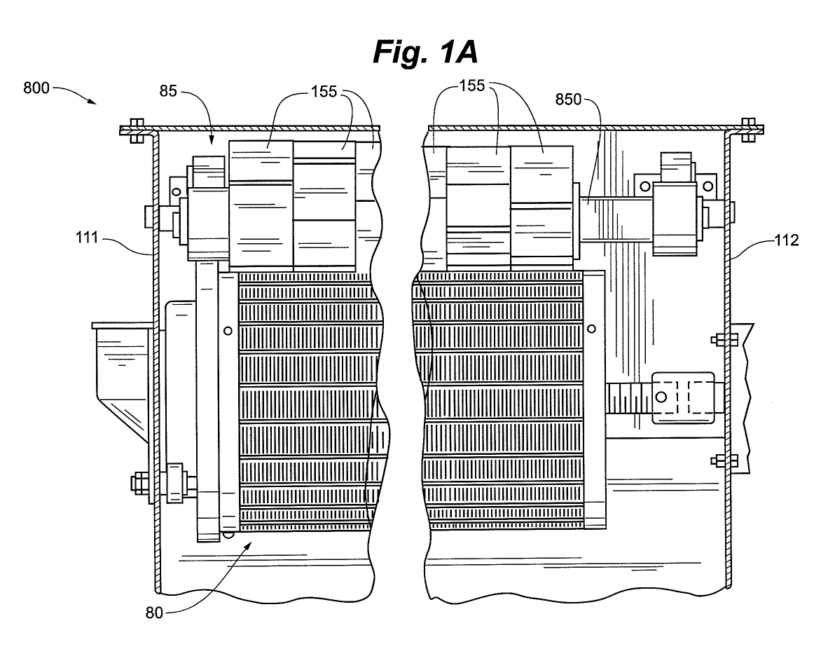

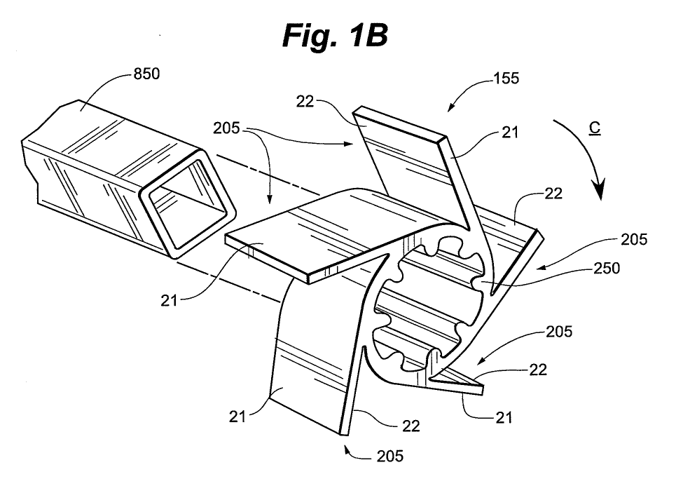

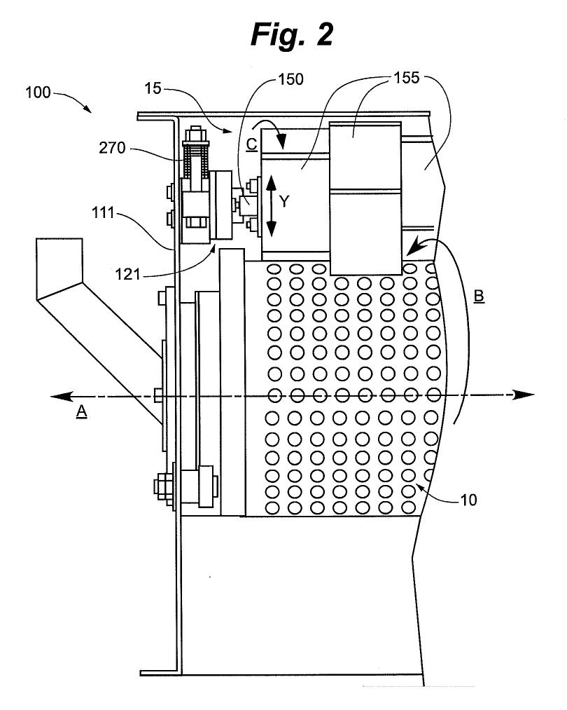

FIG. 1B is an exploded perspective view of a portion of trommel cleaning apparatus 85, which is employed by machine 800, previously introduced, and portions of which may be employed by embodiments of the invention. FIG. 1B illustrates cleaning element 155 including a core 250, for mounting around shaft 850, and a plurality of flexible flappers 205 extending from core 250; each flapper 205 includes a first side 21 and a second side 22. Flapper first side 21 is located for cleaning contact with trommel 80 (FIG. 1), or with a trommel 10, shown in FIG. 2, and flapper second side 22 is located opposite first side 21.

FIG. 2 is a front elevation view of a portion of a separating machine 100, with a front panel removed, according to some embodiments of the invention. FIG. 2 illustrates trommel 10 mounted within sidewall 111 of machine 100, and, extending along a rotational axis A thereof. It should be understood that, machine 100 has a framework similar to machine 800 (FIG. 1A), and that trommel 10 is located between first sidewall 111 and second sidewall 112, which is not shown in FIG. 2, but is illustrated in FIG. 1A. Trommel 10 may be mounted and rotated within machine 100 according to the teachings of aforementioned U.S. Patent '233, which has been incorporated by reference.

FIG. 2 further illustrates a trommel cleaning apparatus 15 mounted alongside trommel 10 and including a shaft 150 on which cleaning elements 155 are mounted. With reference back to FIG. 1B, in conjunction with FIG. 2, it may be appreciated that cleaning elements 155 rotate, per arrow C, when trommel is rotated, per arrow B, and first side 21 of each flexible flapper 205 of each of elements 155 contacts the surface of trommel 10 with a cleaning contact force to dislodge stuck particles from the apertures in the sidewall of trommel 10.

According to embodiments of the invention, cleaning apparatus 15 is adjustable within machine 100 such that at least two cleaning contact forces may be applied to trommel 10, via flappers 205 of cleaning elements 155. In some sorting applications, particles may have sizes causing them to be stuck with a greater force within the apertures of trommel 10, thus, a larger cleaning force is required to remove the stuck particles.

According to the illustrated embodiment, a carrier guide 121 supports cleaning apparatus 15 to allow cleaning apparatus 15 to be moved, per double headed arrow Y, from a first position, in which a first cleaning force is applied by cleaning elements 155, to a second position, in which a second cleaning force is applied by cleaning elements 155. FIG. 2 further illustrates cleaning assembly 15 biased in one of the first and second positions by an optional spring member 270, so that cleaning apparatus 15 must be either pushed or pulled against the force of member 270, to move apparatus 15 from one of the first and second positions to the other. Although FIG. 2 shows only carrier guide 121 and optional spring member 270 mounted to sidewall 111, it should be understood that, according to some embodiments, another carrier guide 121 and another optional spring member 270 are mounted to the opposing sidewall 112 (FIG. 1A) to support cleaning apparatus 15 at either end; also, according to alternate embodiments, one or more carrier guides and/or spring members could be located to support cleaning assembly 15 near a central portion, between either end thereof.

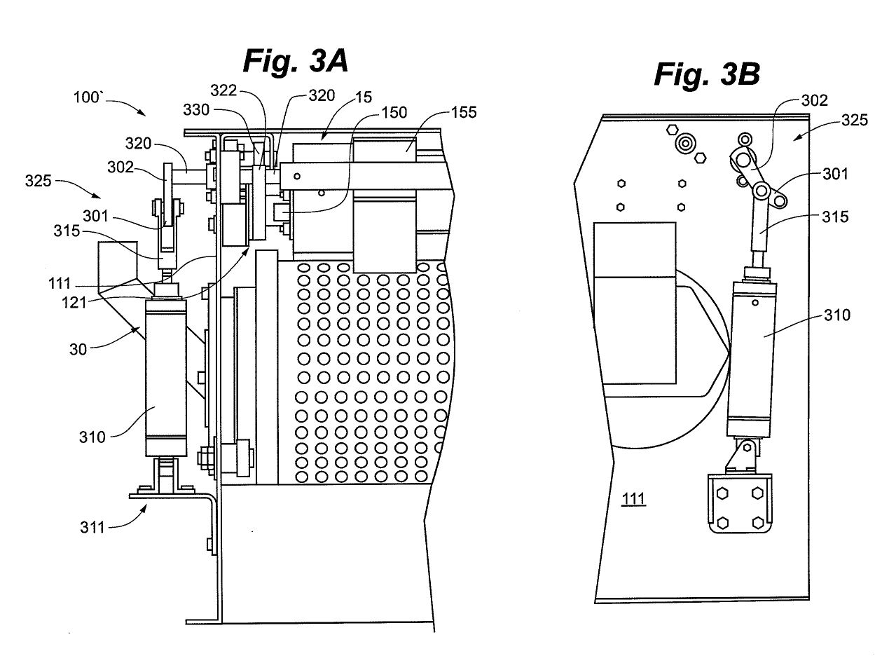

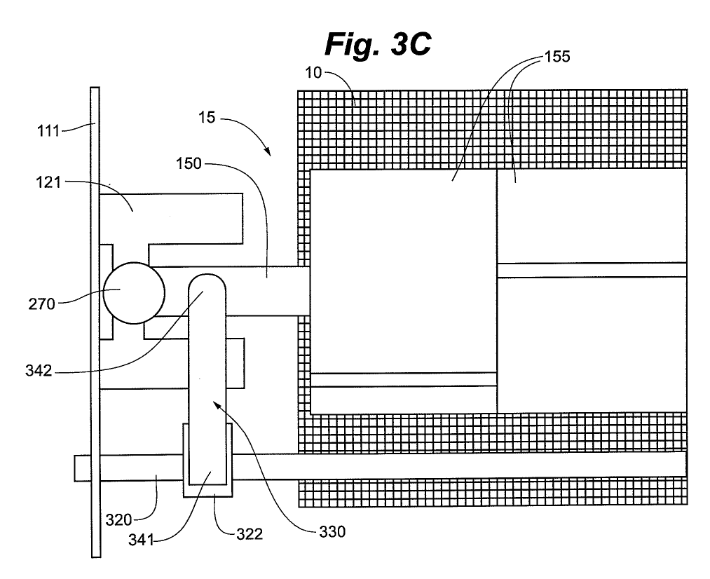

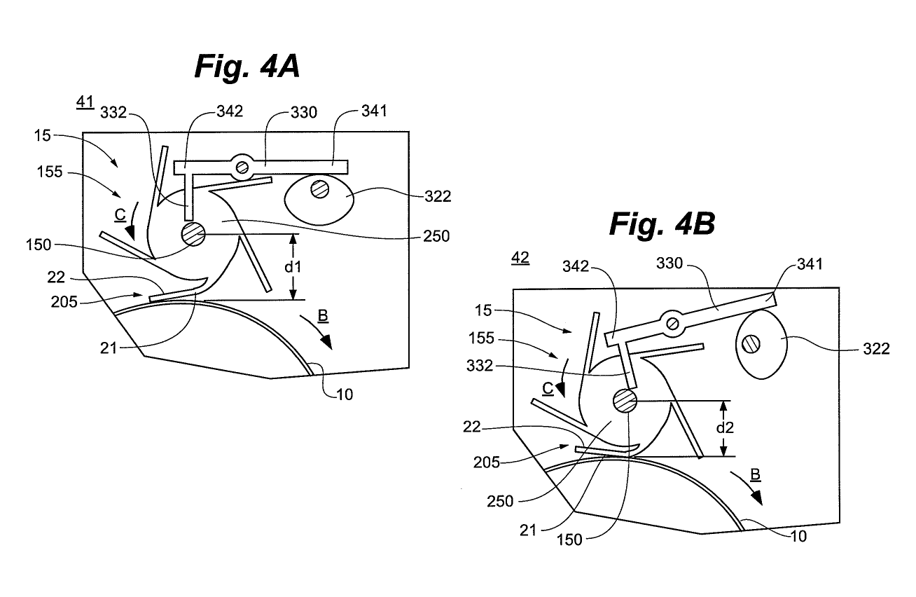

FIG. 3A is a front elevation view of a portion of a separating machine 100′, with a front panel removed, according to some embodiments of the invention; and FIG. 3B is an end view of machine 100′. FIGS. 3A-B illustrate machine 100′ including a driver assembly 30, which is adapted to move cleaning apparatus 15 between the aforementioned first and second positions without requiring an operator to exert significant manual force. Such embodiments are useful for easily moving the cleaning apparatus between the first and second positions. In some embodiments, the driver assembly 30 includes a powered driver assembly, and the embodiment shown includes a piston 310, for example, pneumatic, a linkage assembly 325, coupled to piston 310, a cam shaft 320, coupled to linkage assembly 325, and a lever arm 330, driven by a cam 322 mounted on cam shaft 320. Powered driver assembly 30 may be operated locally or remotely from machine 100′. According to the illustrated embodiment of the powered driver assembly, cleaning apparatus 15 is moved, for example, per arrow Y (FIG. 2), by changing a pressure in piston 310; the change in pressure raises or lowers a linkage coupling 315 of piston 310 to drive first and second linkage arms 301, 302; second linkage arm 302, being fixedly coupled to cam shaft 320, thus rotates cam 322 to raise or lower an end of lever arm 330. With reference to FIG. 3C, which is a schematic top view of a portion of machine 100′, according to some embodiments, a first end 341 of lever arm 330 engages with cam 322, and a second end 342 of lever arm 330 engages with shaft 150 of cleaning assembly 15, for example, as illustrated in FIGS. 4A-B. In other embodiments, the driver assembly 30 includes a manual driver assembly, in which the piston is replaced by a lever arm that allows the operator to manually drive the linkage assembly as described herein.

FIGS. 4A-B are schematics showing first and second positions 41, 42, respectively, of cleaning apparatus 15, as affected by positions of lever arm 330, according to some embodiments of the invention. With reference back to FIG. 2, according to some embodiments, carrier guide 121 constrains movement of cleaning apparatus 15, between first and second positions 41, 42, to a certain direction of movement. For example, the carrier guide 121 may constrain the movement of the cleaning apparatus 15 to a substantially straight line (e.g., generally vertical) as the cleaning apparatus travels between the first and second positions. FIGS. 4A-B illustrate a protruding pin 332 extending from second end 342 of lever arm 330 for contact with shaft 150 of cleaning apparatus 15. FIG. 4A illustrates first end 341 of lever arm 330 resting on cam 322 in a lower position such that pin 332 does not contact or push against shaft 150 of cleaning apparatus 15 and, thus, cleaning element 155 is located a distance d1 from trommel 10, to define first position 41 of cleaning apparatus 15. In this first position, note that the flexible flapper 205 has a relatively uncompressed shape. FIG. 4B illustrates first end 341 of lever arm 330 raised by cam 322, such that pin 332 contacts and pushes against shaft 150 to move cleaning apparatus 15 into second position 42; cleaning element 155 is shown located a distance d2, which is less than d1, to define second position 42 of cleaning apparatus 15. Note that in this second position, the flexible flapper 205 has a relatively compressed shape compared to the first position. This relatively compressed shape applies a greater cleaning force to the trommel 10. According to an exemplary embodiment, a difference between d1 and d2 is approximately one quarter of an inch. With further reference to FIGS. 4A-B, it may be appreciated that a greater cleaning force is applied to trommel 10 by each cleaning element 155 in second position 42, since flappers 205 are ‘compressed’, or bent more tightly around core 250, when first sides 21 thereof come into contact with rotating trommel 10. Thus, according to methods of the invention, a cleaning contact force between each cleaning element 155 of cleaning apparatus 15 and rotating trommel 10 may be adjusted: either increased by moving cleaning apparatus 15 from first position 41 to second position, or decreased by moving cleaning apparatus 15 from second position 42 to first position 41.

Referring back to FIG. 3C, in conjunction with FIGS. 4A-B, optional spring member 270, which was introduced in conjunction with FIG. 2, is shown coupled to cleaning apparatus shaft 150 in order to bias cleaning apparatus 15 in one of first and second positions 41, 42. According to some embodiments, spring member 270 biases cleaning assembly 15 in first position 41, and lever arm 330, pushes against the force of spring 270, via protruding pin 332, to move cleaning apparatus 15 into second position 42.

In the foregoing detailed description, the invention has been described with reference to specific embodiments. However, it may be appreciated that various modifications and changes can be made without departing from the scope of the invention as set forth in the appended claims. For example, a particular design of cleaning elements for a trommel cleaning apparatus has been described, but various other designs of cleaning elements, which are known to those skilled in the art, could be employed by trommel cleaning apparatuses in separating machines of the invention. Furthermore, although powered driver assembly 30 has been described herein, in conjunction with FIGS. 3A-C, it should be noted that alternative powered driver assemblies, for example, including one or more elements of assembly 30 in combination with any other elements known to those skilled in the art, may be employed to move a trommel cleaning apparatus between the first and second positions, according to alternate embodiments of the invention.

1. A separating machine, comprising:
a trommel mounted within a framework of the machine, the trommel extending along a rotational axis thereof between a first sidewall of the framework and a second sidewall of the framework;
a trommel cleaning apparatus comprising at least one cleaning element in a location alongside the trommel for cleaning contact with the trommel, when the trommel is rotated about the rotational axis;
a powered driver assembly adapted to move the cleaning apparatus between a first position and a second position; and
at least one carrier guide supporting the cleaning apparatus and allowing the cleaning apparatus to be moved from the first position to the second position; and
wherein the first position locates the at least one cleaning element at a first distance from the trommel such that the at least one cleaning element comes into cleaning contact with the trommel with a first force, when the trommel is rotated; and
the second position locates the at least one cleaning element at a second distance from the trommel such that the cleaning element comes into cleaning contact with the trommel with a second force, when the trommel is rotated, the second distance being less than the first distance, and the second force being greater than the first force.

2. The machine of claim 1, further comprising a spring member adapted to bias the cleaning apparatus in one of the first and second positions.

3. The machine of claim 2, wherein the biased position corresponds to the first position.

4. The machine of claim 1, further comprising:
a spring member adapted to bias the cleaning apparatus in one of the first and second positions; and
wherein the powered driver assembly includes a lever arm having an end driven to move the cleaning apparatus between the first and the second positions; and
the end of the lever arm is driven against a force of the spring member in order to move the cleaning apparatus out of the biased position of one of the first and second positions and into the other of the first and second positions.

5. The machine of claim 1, wherein:
the powered driver assembly includes a cam shaft and a cam fixedly mounted on the cam shaft; and
a driven rotation of the cam shaft causes the cam to move the cleaning apparatus between the first and the second positions.

6. The machine of claim 5, further comprising:
a spring member adapted to bias the cleaning apparatus in one of the first and second positions; and
wherein the driven rotation of the cam shaft causes the cam to move the cleaning apparatus against a force of the spring member in order to move the cleaning apparatus out of the biased position of one of the first and second positions and into the other of the first and second positions.

7. The machine of claim 5, wherein:
the powered driver assembly further includes a piston and a linkage assembly coupled to the piston; and
the linkage assembly is coupled to the cam shaft and the piston drives the rotation of the cam shaft.

8. The machine of claim 5, wherein:
the powered driver assembly further includes a lever arm having a first end and a second end;
the lever arm mounted in proximity to the cam for engagement of the cam with the first end of the lever arm; and
the driven rotation causes the cam to move the first end of the lever arm such that the second end of the lever arm moves the cleaning assembly.

9. The machine of claim 8, wherein the lever arm further includes a pin extending from the second end thereof, the pin engaging the cleaning assembly to move the cleaning assembly.

10. The machine of claim 8, further comprising:
a spring member adapted to bias the cleaning apparatus in one of the first and second positions; and
wherein the driven second end of the lever arm moves the cleaning assembly against a force of the spring member in order to move the cleaning apparatus out of the biased position of one of the first and second positions and into the other of the first and second positions.

11. The machine of claim 10, wherein the biased position corresponds to the first position.

12. The machine of claim 1, wherein the at least one carrier guide comprises a first carrier guide mounted to the first sidewall of the machine framework and a second carrier guide mounted to the second sidewall of the machine framework.

13. The machine of claim 12, further comprising:
a spring member adapted to bias the cleaning apparatus in one of the first and second positions; and
wherein the powered driver assembly includes a first lever arm, located in proximity to the first carrier guide, and a second lever arm, located in proximity to the second carrier guide;
each of the first and second lever arms have an end driven to move the cleaning apparatus between the first and the second positions; and
each of the lever arm ends is driven against a force of the spring member in order to move the cleaning apparatus out of the biased position of one of the first and second positions and into the other of the first and second positions.

14. The machine of claim 12, wherein:
the powered driver assembly includes a cam shaft, a first cam fixedly mounted on the cam shaft in proximity to the first carrier guide, and a second cam fixedly mounted on the cam shaft in proximity to the second carrier guide; and
a driven rotation of the cam shaft causes the first and second cams to move the cleaning apparatus between the first and second positions.

15. The machine of claim 14, wherein:
the powered driver assembly further includes a first piston and a first linkage assembly coupled to the first piston, and a second piston and a second linkage assembly coupled to the second piston;
the first piston and the first linkage assembly are located in proximity to the first carrier guide;
the second piston and the second linkage assembly are located in proximity to the second carrier guide; and
the first and second linkage assemblies are coupled to the cam shaft and the first and second pistons drive the rotation of the cam shaft.

16. The machine of claim 14, wherein:
the powered driver assembly further includes a first lever arm and a second lever arm, each of the first and second lever arms having a first and second end;
the first lever arm mounted in proximity to the first cam for engagement of the first cam with the first end of the first lever arm;
the second lever arm mounted in proximity to the second cam for engagement of the second cam with the first end of the second lever arm; and
the driven rotation of the cam shaft causes the first and second cams to move the first end of the first lever arm and the first end of the second lever arm, respectively, such that the second ends of the first and second lever arms move the cleaning assembly.

17. The machine of claim 1, wherein the carrier guide allows the cleaning apparatus to be moved linearly from the first position to the second position.

18. The machine of claim 1, wherein the at least one cleaning element is mounted on a shaft of the cleaning apparatus and includes a core, through which the shaft extends, and at least one flexible flapper extending outward from the core; the at least one flapper including a first side and a second side, the first side being positioned for cleaning contact with the trommel, when the trommel is rotated about the rotational axis, and the second side being located opposite the first side.

19. A method for adjusting a cleaning contact force between at least one cleaning element of a cleaning apparatus and a trommel, the method comprising:
activating a powered driver assembly to move the cleaning apparatus in a substantially straight line from a first position to a second position, the movement being constrained by at least one carrier guide that supports the cleaning apparatus;
wherein the at least one cleaning element contacts the trommel for cleaning with a first force, when the trommel is rotated and the cleaning apparatus is located at the first position; and
the at least one cleaning element contacts the trommel for cleaning with a second force, when the trommel is rotated and the cleaning apparatus is located at the second position, the second force being greater than the first force.

20. The method of claim 19, wherein the powered driver assembly moves the cleaning apparatus against a biasing force that holds the cleaning apparatus in the first position.

21. The method of claim 20, further comprising activating the powered driver assembly to move the cleaning apparatus from the second position to the first position.

22. The method of claim 19, wherein the at least one cleaning element is mounted on a shaft of the cleaning apparatus and includes a core, through which the shaft extends, and at least one flexible flapper extending outward from the core; the at least one flapper including a first side and a second side, the first side being positioned for cleaning contact with the trommel, when the trommel is rotated about the rotational axis, and the second side being located opposite the first side.

23. A separating machine, comprising:
a trommel mounted within a framework of the machine, the trommel extending along a rotational axis thereof between a first sidewall of the framework and a second sidewall of the framework;
a trommel cleaning apparatus comprising at least one cleaning element in a location alongside the trommel for cleaning contact with the trommel, when the trommel is rotated about the rotational axis;
a driver assembly adapted to move the cleaning apparatus between a first position and a second position, the driver assembly having a cam shaft and a cam fixedly mounted on the cam shaft, wherein a driven rotation of the cam shaft causes the cam to move the cleaning apparatus between the first and the second positions; and
at least one carrier guide supporting the cleaning apparatus and allowing the cleaning apparatus to be moved from the first position to the second position; and
wherein the first position locates the at least one cleaning element at a first distance from the trommel such that the at least one cleaning element comes into cleaning contact with the trommel with a first force, when the trommel is rotated; and
the second position locates the at least one cleaning element at a second distance from the trommel such that the cleaning element comes into cleaning contact with the trommel with a second force, when the trommel is rotated, the second distance being less than the first distance, and the second force being greater than the first force.

24. The separating machine of claim 23, wherein the driver assembly includes a powered driver assembly.
